(19) United States
(12) Patent Application Publication
(10) Pub. No.: US 2023/0177901 A1
(43) Pub. Date: Jun. 8, 2023

(54) SYSTEM AND METHOD FOR SECURED DOOR ENTRY

(71) Applicant: Rodrigo De Andreade Lima, Katy, TX (US)

(72) Inventor: Rodrigo De Andreade Lima, Katy, TX (US)

(21) Appl. No.: 17/720,967

(22) Filed: Apr. 14, 2022

Related U.S. Application Data
(60) Provisional application No. 63/285,460, filed on Dec. 2, 2021.

(51) Int. Cl. G07C 9/00

(52) U.S. Cl. CPC G07C 9/00571; G07C 9/00309

(57) ABSTRACT

A system and method for secure door entry without the need for sharing passcodes or physical keys. The system includes a relay unit coupled to a door lock, the relay unit can unlock the door lock. The method includes the steps of receiving an unlock request from a user device. The unlock request can include a passcode or a request to connect to a resident device. The system can then verify the unlock request. Upon verification, the system can send a release signal to the relay unit, wherein the relay unit can unlock the door lock upon receiving the release signal.

### FIELD OF INVENTION

The present invention relates to a system and method for controlling door entry, and more particularly, the present invention relates a system and method for remotely operating a door lock.

### BACKGROUND

An entry to enclosed premises is generally secured by a door and the opening of the door is secured by a lock. The door locks are essential for the security of the enclosed premises. A variety of door locks are available that differ in design, mechanism, cost, materials, and the like. Although all the locks are mechanical, the key for the locks can be physical or digital. The physical keys that are inserted in locks to lock and unlock are traditional and still widely used. Digital keys such as passcodes and biometrics have certain advantages over physical keys, the major advantage is no need to carry the physical keys. An owner or supervisor can share the passcode over the phone with a visitor and does not need to be present at the door. The passcode can be easily shared with many people. Similarly, many people can be registered for biometric entry.

However, the known digital method also suffers from some major drawbacks. The passcode can be easily revealed to unauthorized users and needs to be changed frequently. Moreover, the passcode must be changed every time after sharing the passcode with a temporary visitor. In the case of biometrics, registering the biometrics for temporary visitors is not practical.

Thus, a need is appreciated for a system and method to overcome the aforesaid drawbacks of digital door entry systems and has all the advantages of the digital door entry systems.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for secure door entry without revealing passcodes or registering the biometrics.

It is another object of the present invention that the door locks can be unlocked remotely.

It is still another object of the present invention that the door can be unlocked without needing the owner or supervisor to be present at the door.

It is yet another object of the present invention that the status of locks can be notified or viewed remotely.

In one aspect, disclosed is a system for secure door entry, the system comprising a processor and a memory, the system further comprises a relay unit operably coupled to a door lock, the relay unit configured to unlock the door lock, the system is configured to implement a method comprising the steps of receiving an unlock request, by a main module implemented within the system upon execution by the processor, from a user device; verifying the unlock request; and upon verification, transmitting, by the main module, to the relay unit, a release signal, wherein the relay unit is configured to unlock the door lock upon receiving the release signal. The method further comprises the steps of providing a user interface on the user device, by an interface module upon execution by the processor, the user interface configured to receive a passcode, wherein the unlock request comprises the passcode. The unlock request comprises a passcode, wherein the passcode is received by an interactive voice response (IVR) module also implemented within the system.

In one implementation of the system, the method further comprises the steps of upon receiving the unlock request, establishing a voice call between the user device and a resident device, wherein, the verifying step comprises receiving an instruction from the resident device during the voice call, wherein the instruction is generated by pressing a key on the resident device during the voice call, wherein upon receiving the instruction, the release signal is transmitted. The method further comprises the step of providing a user interface on the user device, the user interface configured to receive the unlock request. The unlock request comprises a pass code. The unlock request comprises a request to establish a voice call with a resident device. The method further comprises the step of scanning a barcode, wherein the barcode represents a unique URL associated with the relay unit; upon scanning the bar code, reading the unique URL from the barcode; and upon reading, providing the user interface on the user device.

In one aspect, disclosed is a method for secure door entry, the method implemented within a system comprising a processor and a memory, the system further comprises a relay unit operably coupled to a door lock, the relay unit configured to unlock the door lock, the method comprising the steps of receiving an unlock request, by a main module implemented within the system upon execution by the processor, from a user device; verifying the unlock request; and upon verification, transmitting, by the main module, to the relay unit, a release signal, wherein the relay unit is configured to unlock the door lock upon receiving the release signal.

### BRIEF DESCRIPTION OF THE DRAWINGS

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

FIG. 1 is a block diagram showing an architecture and environment of the system including a relay unit, according to an exemplary embodiment of the present invention.

FIG. 2 shows a sticker including a QR code and a phone number, according to an exemplary embodiment of the present invention.

FIG. 3 shows a screen of an interface presented on a user device, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

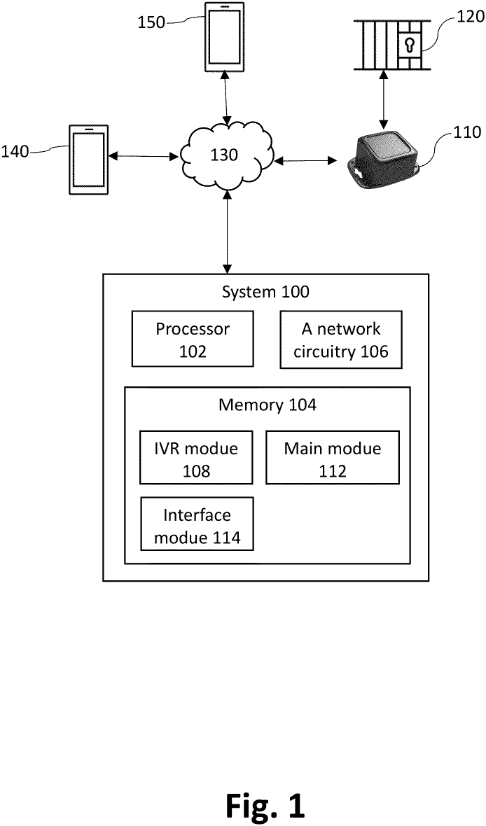

Disclosed is a system and method for controlling door entry or more specifically operating a door lock. The disclosed system may allow an owner or supervisor of enclosed premises to remotely open the lock without sharing any passcodes. Visitors can be provided entry through a door without the need for the owner or supervisor to be present at the door. Passcodes can be entered safely through a smartphone. Referring to FIG. 1 which is a block diagram showing the architecture and environment of the disclosed system 100. The disclosed system 100 can also include a relay unit 110 that can be coupled to a door lock 120 for locking and unlocking the door lock. The door locks can be manufactured with the relay unit. Alternatively, the relay unit can retrofit into an existing door lock. The relay unit 110 can be connected to system 100 through a network 130. The relay unit 110 can receive release signals from system 100 through network 130 and in response to the release signal, the relay unit can unlock the door lock. Besides unlocking the door lock, the door can also be opened and closed using suitable machinery by the relay unit. Also, the machinery can provide for automatically closing the door and engaging the door lock. The relay unit 110 can also send status signals through network 130 to the disclosed system 100 indicating the status of the door lock. The network 130 can be wired or wireless. The network can be a local area network or a wide area network and includes the internet. The network can also be a PSTN network or a cellular network. The network can also be a combination of the PSTN network and the internet. Suitable examples of networks can include 2G, 3G, 4G, 5G, Wi-Fi, Bluetooth, Broadband, Satellite internet, and the like. Suitable internet protocols, such as TCP/IP can also be used for a secured or unsecured internet connection. In the case of the PSTN network, the relay signals and the status signals can be transmitted using DTMF signaling. While FIG. 1 shows a single network 130 connecting the relay unit 110 to the system 100, it is understood that one or more networks can connect the relay unit 110 and the system 100.

The system 100 can include a processor 102, a memory 104, and a network circuitry 106. The network circuitry 106 can allow the system 100 to connect to external networks, such as the network 130. The processor 102 can be any logic circuitry that responds to, and processes instructions fetched from the memory 104. The memory 104 may include one or more memory chips capable of storing data and allowing any storage location to be directly accessed by the processor 102. The memory 104 can include modules that can be software, code, program, or a set of instructions which upon execution by the processor can perform one or more steps of the disclosed methodology. The memory 104 can include an IVR module 108, a main module 112, and an interface module 114. The interface module 114 upon execution by a processor 102 can provide an interface on a user device and a resident device. The interface can permit a user or a resident to communicate with the disclosed system for setting a passcode, viewing the directory, or operating the door lock. The IVR module 108 can guide the user to receive unlock request. The main module 112 can communicate with the user device and resident device for operating the door lock. The “resident” herein includes an authorized person for unlocking the door lock and can include the owner of the residence, family member of the owner, a supervisor, and like persons. The “resident device” refers to a device through which a resident can communicate with the disclosed system. The “user” refers to a person willing to enter secure enclosed premises and can include visitors, workmen, salesmen, physicians, guests, friends, relatives, and the like. The “resident” when willing to enter the enclosed premises can also be referred to as the “user”. The “user device” refers to an electronic device through which a “user” can communicate with the disclosed system. The resident device and the user device can be electronic communication devices, such as but not limited to a smartwatch, cell phone, smartphone, tablet computer, and the like.

As shown in FIG. 1, the disclosed system 100 can communicate with a user device 140 through the network 130. While FIG. 1 shows a single user device 140 interacting with the system 100 through the network, a skilled person will appreciate that more than one user device can simultaneously or at different times can connect to the disclosed system 100. Moreover, the different user devices can connect through different networks. The relay unit 110 and the user device 140 can connect through the same or different networks without departing from the scope of the present invention. Also, the network can support added protocols, such as VoIP protocols for establishing voice calls between the user device and the resident device.

FIG. 1 also shows the resident device 150 connected to the disclosed system 100 through the network 130. While FIG. 1 shows a single resident device to connect with the system 100 through the network, a skilled person will appreciate that more than one resident device can simultaneously or at different times can connect to the disclosed system 100. Moreover, the different resident devices can connect through different networks. FIG. 1 shows a single network 130 connecting different devices for illustration purposes only, and a skilled person will appreciate that the different devices including the relay unit can connect through different networks.

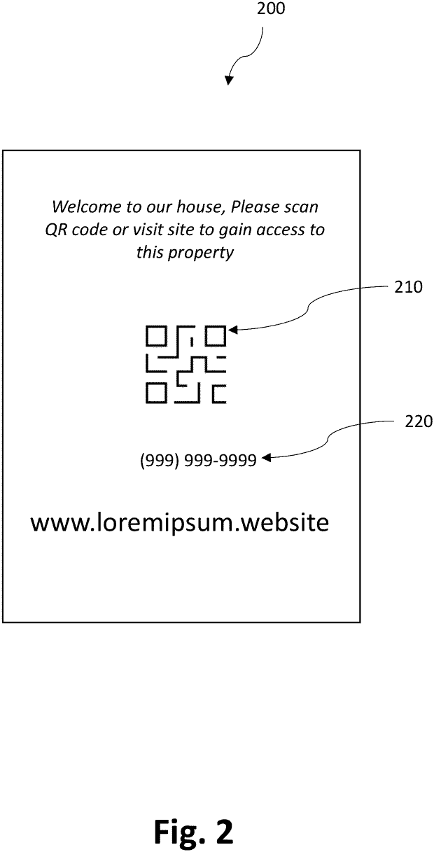

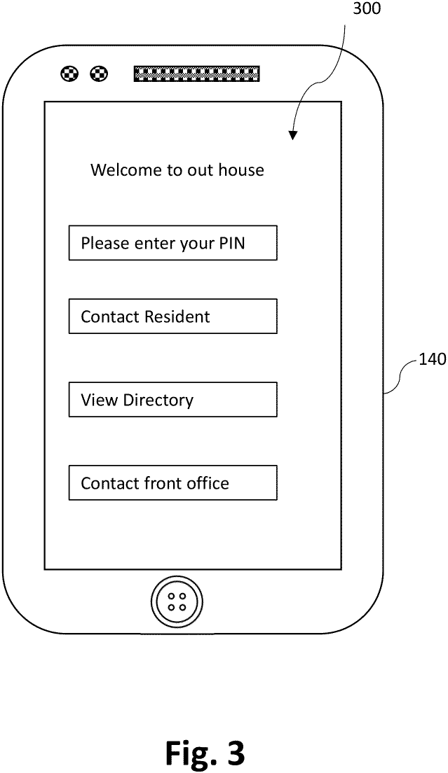

Referring to FIG. 2 which shows a sticker 200 that can adhere outside a door, such as on the door, to a wall adjacent to the door, near a lift, or an elevator. The sticker can include a barcode 210 and a phone number 220. The barcode 210 can graphically represent a unique URL associated with the relay unit 110. The graphical representation can be in a form of QR code, matrix bar code, and the like. The “bar code” herein refers to any such scannable and readable graphical representation of information. Moreover, the phone number 220 can unique and assigned for the relay unit 110. The user upon visiting the enclosed premises can scan the bar code using the user device 140 which downloads a user interface provided by the interface module 114 on the user device. An exemplary embodiment of a screen of the interface is shown in FIG. 3. The interface module 114 upon execution by processor 102 can provide a user interface 300 on the user device 140 and a resident interface on the resident device 150. The user interface can be provided as application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS.

In an alternate embodiment, instead of scanning the bar code, the user can also dial the given phone number 220 on the sticker 200 using the normal dial pad on the user device and establish a voice call through a cellular internet, PSTN network, or similar network. Also, the user interface can provide a screen wherein a user can connect to the disclosed system through a VoIP connection.

Referring to FIG. 3, which shows a screen of the interface 300 presented on the user device 140. The user can be provided with an option to enter a predefined passcode for unlocking the door. The passcode can be preset by the resident, using the resident interface. Generally, the family members can have the passcode which they can use to unlock the door. Moreover, the family member may not need to scan the bar code everytime, but the same can be preconfigured in the user device. Upon dialing the given number 220 through the user device, the user device can connect to the IVR module 108 of the system 100. The IVR module 108 can guide the user through different options to gain entry into the secured premises. For example, the IVR module 108 can instruct the user to enter the passcode, wherein the user can enter the passcode using a dial pad or keyboard of the user device. The passcode can be transferred to the system 100 through the internet or DTMF signals.

The main module 112 can receive the passcode from the user device 140 and can then verify the passcode. Upon successful matching, the main module 112 can send a release signal to the associated relay unit 110, and the relay unit 110 upon receiving the release signal from the main module 112 can unlock the door lock 120.

In case, the user does not have the passcode, the user can call the resident device through interface 300. An option “contact resident” can be provided in the interface, clicking on which, a voice call can be established with the resident device. The voice call can be made through VoIP protocol, PSTN network, cellular network, and a combination thereof, or any other means of establishing a voice call between two computing devices. The resident while taking with the user can press any key on the resident device to send an instruction to the main module 112 t transmit the release signal to the relay unit 110, thus unlocking the door lock 120. The screen shown in FIG. 3 has an option to contact the resident. The user can click the option to establish a voice call with the resident. Alternatively, the user can select an option from a menu on IVR module 108 to connect with the resident.

A directory, “view director” in interface 300, can also be provided that includes the phone numbers, wherein a user may not need to dial the phone number 220 on the sticker 200 but can search the phone number in the directory through the interface 300. The option of having the directory can be particularly useful for frequent visitors, such as friends and relatives.

Generally, in a building having multiple apartments and the like, a front desk or reception is there, and the supervisor can be authorized to control door entry. The interface can also provide an option to call the front desk, “contact the office” in FIG. 3.

Often a visitor knows a specific person in a family whom he is visiting. For example, the visitor can be a friend of a family member. More than one resident device can be registered for a single relay unit, i.e., the door can be unlocked by more than one resident devices belonging to different residents. Herein the main module 112 can receive the name of the resident from the user and connect a voice call between the user and the named resident. The user can speak the name of the resident to IVR module 108, and the IVR module 108 can use voice recognition algorithms to determine the name of the resident. For example, the IVR module 108 can ask the question “whom do you want to visit.”

The disclosed system can also be used in commercial places, such as paid parking lots, and the like. The user can scan the code provided at the entry and pay the amount. Upon confirmation of the payment, the door can be unlocked by the disclosed system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for secure door entry, the system comprising a processor and a memory, the system further comprises a relay unit operably coupled to a door lock, the relay unit configured to unlock the door lock, the system is configured to implement a method comprising the steps of:
receiving an unlock request, by a main module implemented within the system upon execution by the processor, from a user device;
verifying the unlock request; and
upon verification, transmitting, by the main module, to the relay unit, a release signal, wherein the relay unit is configured to unlock the door lock upon receiving the release signal.

2. The system according to claim 1, wherein the method further comprises the steps of:
providing a user interface on the user device, by an interface module upon execution by the processor, the user interface configured to receive a passcode, wherein the unlock request comprises the passcode.

3. The system according to claim 1, wherein the unlock request comprises a passcode, wherein the passcode is received by an interactive voice response (IVR) module also implemented within the system.

4. The system according to claim 1, wherein the method further comprises the steps of:
upon receiving the unlock request, establishing a voice call between the user device and a resident device,
wherein, the verifying step comprises receiving an instruction from the resident device during the voice call,
wherein the instruction is generated by pressing a key on the resident device during the voice call,
wherein upon receiving the instruction, the release signal is transmitted.

5. The system according to claim 1, wherein the method further comprises the step of:
providing a user interface on the user device, the user interface configured to receive the unlock request.

6. The system according to claim 5, wherein the unlock request comprises a pass code.

7. The system according to claim 5, wherein the unlock request comprises a request to establish a voice call with a resident device.

8. The system according to claim 5, wherein the method further comprises the step of:
scanning a barcode, wherein the barcode represents a unique URL associated with the relay unit;
upon scanning the barcode, reading the unique URL from the barcode; and
upon reading, providing the user interface on the user device.

9. A method for secure door entry, the method implemented within a system comprising a processor and a memory, the system further comprises a relay unit operably coupled to a door lock, the relay unit configured to unlock the door lock, the method comprising the steps of:
receiving an unlock request, by a main module implemented within the system upon execution by the processor, from a user device;
verifying the unlock request; and
upon verification, transmitting, by the main module, to the relay unit, a release signal, wherein the relay unit is configured to unlock the door lock upon receiving the release signal.

10. The method according to claim 9, wherein the method further comprises the steps of:
providing a user interface on the user device, by an interface module upon execution by the processor, the user interface configured to receive a passcode, wherein the unlock request comprises the passcode.

11. The method according to claim 9, wherein the unlock request comprises a passcode, wherein the passcode is received by an interactive voice response (IVR) module also implemented within the system.

12. The method according to claim 9, wherein the method further comprises the steps of:
upon receiving the unlock request, establishing a voice call between the user device and a resident device,
wherein, the verifying step comprises receiving an instruction from the resident device during the voice call,
wherein the instruction is generated by pressing a key on the resident device during the voice call,
wherein upon receiving the instruction, the release signal is transmitted.

13. The method according to claim 9, wherein the method further comprises the step of:
providing a user interface on the user device, the user interface configured to receive the unlock request.

14. The method according to claim 13, wherein the unlock request comprises a pass code.

15. The method according to claim 13, wherein the unlock request comprises a request to establish a voice call with a resident device.

16. The method according to claim 13, wherein the method further comprises the step of:
scanning a barcode, wherein the barcode represents a unique URL associated with the relay unit;
upon scanning the bar code, reading the unique URL from the barcode; and
upon reading, providing the user interface on the user device.
